(19) United States
(12) Patent Application Publication
(10) Pub. No.: US 2004/0111868 A1
(43) Pub. Date: Jun. 17, 2004

(54) Gas sensor element designed to ensure required measurement accuracy

(75) Inventors: Toru Katafuchi, Kariya-shi (JP); Keigo Mizutani, Okazaki-shi (JP); Daisuke Makino, Ichinomiya-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Kariya-city (JP)

(21) Appl. No.: 10/703,079

(22) Filed: Nov. 7, 2003

(30) Foreign Application Priority Data
Nov. 8, 2002 (JP) 2002-324909

(51) Int. Cl. G01N 27/26

(52) U.S. Cl. 29/592.1; 204/426

(57) ABSTRACT

A gas sensor element is provided which is made of a laminate of an oxygen pump cell, a sensor cell, an oxygen monitor cell, and a heater. The laminate has affixed thereto terminals for establishing transmission of signals between themselves and an external device and also has conductive lines formed on portions of an outer surface of the laminate which connect between the respective cells and the terminals. This structure ensures a required degree of insulation resistance between the heater and the cells and also eliminates the disadvantages of a conventional structure that electric disconnections between the terminals and the cells or cracks occur in the laminate.

### BACKGROUND OF THE INVENTION

1. Technical Field of the Invention

The present invention relates generally to a gas sensor element for use in measuring the concentration of a given gas component such as nitrogen oxides (NOx) contained in exhaust gasses of automotive engines and a production method thereof.

2. Background Art

The air population arising from automobile exhaust fumes has posed serious problems with modern life. The emission regulation, thus, has become severe year by year. For instance, in order to decrease harmful products contained in exhaust emissions, burning control systems working to control burning in the engine to inhibit generation of the harmful products or emission control systems working to clean up the exhaust emissions using a catalytic converter have been proposed. Techniques have also been proposed in the prior art for measuring the concentration of nitrogen oxides (NOx) that are typically harmful products contained in automotive exhaust gasses and feeding such a result back to the above systems to enhance the efficiency of purifying the exhaust emissions. For these reasons, gas sensor elements are being sought which are capable of measuring the concentration of NOx in automotive exhaust emissions accurately. For example, Japanese Patent No. 2885336 (corresponding to U.S. Pat. No. 5,866,799) teaches one example of such gas sensor elements.

FIGS. 7 and 8 show an example of a known laminated gas sensor element using an oxygen ion-conductive solid electrolyte material.

The gas sensor element 1 consists essentially of solid electrolyte layers 51 and 52, spacers 61, 62, 63, and 64, and a heater 9. The solid electrolyte layers 51 and 52 form an inner cavity 7 into which exhaust gasses of an automotive engine are admitted through a porous protective layer 12 and a pinhole 11. The inner cavity 7 is made up of a first measurement gas chamber 7a and a second measurement gas chamber 7b. Reference gas chambers 81 and 82 are formed outside the solid electrolyte layers 51 and 52 which lead to the atmosphere. An oxygen pump cell 2 made up of the solid electrolyte layer 51 and a pair of electrodes 2a and 2b faces the first measurement gas chamber 7a. The oxygen pump cell 2 is responsive to application of voltage thereto to pump oxygen molecules into or out of the first measurement gas chamber 7a.

A monitor cell 3 made up of the solid electrolyte layer 52 and a pair of electrodes 3a and 3b faces the second measurement gas chamber 7b. The oxygen pump cell 2 is so feedback-controlled that the concentration of oxygen within the second measurement gas chamber 7b, as measured by the monitor cell 3 may be kept constant and works to keep the concentration of oxygen within the inner cavity 7 at a given lower level. A sensor cell made up of the solid electrolyte layer 52 and a pair of electrodes 4a and 4b affixed to the surfaces of the solid electrolyte layer 52 faces the second measurement gas chamber 7b and works to decompose NOx molecules and measure the concentration of oxygen produced by the decomposition of NOx.

As described above, the concentration of oxygen within the second measurement gas chamber 7b is so controlled as to be kept constant. The amount of oxygen ions traveling through the sensor cell 4, that is, the magnitude of oxygen ion current flowing through the sensor cell 4 will, therefore, be a function of the concentration of NOx within the second measurement gas chamber 7b. The high accuracy of determining the concentration of NOx contained in the exhaust gasses is ensured regardless of a change in concentration of oxygen in the exhaust gasses by measuring the current flowing through the sensor cell 4.

The current flowing through the sensor cell 4 as a function of the concentration of NOx usually has a minute value on the order of μA. Therefore, if an insulation resistance between the heater 9 and the cells 2, 3, and 4 is undesirably small, it may result in an error in measuring the concentration of NOx. The above described gas sensor element uses, as clearly shown in FIG. 9, through holes SH in electrically connecting each of the cells 2, 3, and 4 to terminals P for transmitting or receiving signals to or from an external device. We have found that this structure is insufficient in insulation between the heater 9 and the respective cells 2, 3, and 4, which poses the disadvantage that the current flowing in the heater 9 leaks into the oxygen pump cell 2, the sensor cell 4, and the monitor cell 3, thus resulting in decreased measurement accuracy thereof. The structure also encounters the drawback in that baking in production processes of the gas sensor element 1 may result in electric disconnections of the terminals P from the cells 2, 3, and 4 or physical cracks extending from the through holes SH, which will lead to decrease in production efficiency and increase in production cost.

### SUMMARY OF THE INVENTION

It is therefore a principal object of the invention to avoid the disadvantages of the prior art.

It is another object of the invention to provide a gas sensor element designed to provide required insulation resistance between a heater and oxygen pump cell, a sensor cell, and/or a monitor cell to ensure the accuracy of measuring the concentration of a gas insensitively to the current leaking from the heater.

According to one aspect of the invention, there is provided a gas sensor element which may be installed in a gas sensor for automotive vehicles. The gas sensor element comprises: (a) a laminated body having formed therein an inner chamber into which measurement gasses are admitted under a given diffusion resistance; (b) an oxygen pump cell formed in said laminated body, including an oxygen ion-conductive solid electrolyte body and first and second pump cell electrodes affixed to surfaces of the solid electrolyte body, the first pump cell electrode being exposed to said inner chamber, said oxygen pump cell being responsive to application of a voltage across the first and second pump cell electrodes to selectively pump oxygen molecules into and out of said inner chamber for adjusting a concentration of oxygen within said inner chamber to a desired value; (c) a sensor cell formed in said laminated body, including an oxygen ion-conductive solid electrolyte body and first and second sensor cell electrodes, the first sensor cell electrode being exposed to said inner chamber, said sensor cell working to produce a signal as a function of a concentration of a predetermined component of the measurement gasses; (d) a heater provided in said laminated body, working to heat said oxygen pump cell and said sensor cell up to a desired activatable temperature; (e) terminals affixed to a surface of said laminated body for establishing transmission of electric signals between the gas sensor element and an external device; and (f) a conductive member formed on an outer surface of said laminated body which establishes an electric connection between one of said terminals and a lead of at least one of said oxygen pump cell and said sensor cell.

Specifically, the one of the terminals is electrically joined to the lead through the outer surface of the laminated body without use of through holes which are employed in the conventional structure, as shown in FIG. 9. This structure ensures a required degree of insulation resistance between the heater and the oxygen pump cell and/or the sensor cell to ensure the accuracy of measuring the concentration of the predetermined component of the measurement gasses insensitively to the current leaking from the heater and also eliminates the disadvantages of the conventional structure, as illustrated in FIG. 9, that electric disconnections between the terminals P1 and P2 and the respective cells 2, 3, and 4 or cracks occur in the through holes SH. This results in improved production efficiency and decreased production costs of the gas sensor element.

In the preferred mode of the invention, the gas sensor element further comprises a monitor cell and a second conductive member. The monitor cell is formed in said laminated body and includes an oxygen ion-conductive solid electrolyte body and first and second monitor cell electrodes. The first monitor cell electrode is exposed to said inner chamber. The monitor cell works to produce a signal indicative of a concentration of oxygen within said inner chamber. The second conductive member establishes an electric connection between a lead of said monitor cell and a terminal formed on the surface of said laminated body for establishing transmission of a signal between the lead of said monitor cell and the external device.

The voltage applied to said oxygen pump cell may is controlled as a function of the signal produced by said monitor cell.

The signal produced by said sensor cell indicating the concentration of the predetermined component of the measurement gasses is provided by a current flowing through said sensor cell.

The signal produced by said monitor cell indicating the concentration of oxygen within said inner chamber is provided by a current flowing through said monitor cell.

The signal produced by said monitor cell indicating the concentration of oxygen within said inner chamber may alternatively be provided by an electromotive force developed in said monitor cell.

The concentration of the predetermined component of the measurement gasses may be determined as a function of a difference between values of the currents flowing through said sensor cell and said monitor cell.

The gas sensor element may further comprises an insulating layer interposed between said conductive member and the surface of said laminated body.

According to the second aspect of the invention, there is provided a method of producing a gas sensor element which comprises the steps of: (a) preparing a laminated body having formed therein an inner chamber into which measurement gasses are admitted under a given diffusion resistance, said laminated body including an oxygen pump cell, a sensor cell, a monitor cell, and a heater, the oxygen pump cell including an oxygen ion-conducting solid electrolyte body and first and second pump cell electrodes affixed to surfaces of the solid electrolyte body one of which is exposed to said inner chamber, said oxygen pump cell being responsive to application of a voltage across the first and second pump cell electrodes to selectively pump oxygen molecules into and out of said inner chamber for adjusting a concentration of oxygen within said inner chamber to a desired value, the sensor cell including an oxygen ion-conducting solid electrolyte body and first and second sensor cell electrodes one of which is exposed to said inner chamber, said sensor cell working to produce a signal as a function of a concentration of a predetermined component of the measurement gasses, the monitor cell including an oxygen ion-conducting solid electrolyte body and first and second monitor cell electrodes one of which is exposed to said inner chamber, said monitor cell working to produce a signal indicative of a concentration of oxygen within said inner chamber, the heater working to heat said oxygen pump cell, said sensor cell, and said monitor cell up to a desired activatable temperature; (b) affixing terminals to a surface of said laminated body for establishing transmission of electric signals between the gas sensor element and an external device; and (c) forming a conductive member on a surface of said laminated body which establishes an electric connection between one of said terminals and a lead of at least one of said oxygen pump cell and said sensor cell.

Specifically, the one of the terminals is electrically joined to the lead through the outer surface of the laminated body without use of through holes which are employed in the conventional structure, as shown in FIG. 9. This production method ensures a required degree of insulation resistance between the heater and the oxygen pump cell and/or the sensor cell to ensure the accuracy of measuring the concentration of the predetermined component of the measurement gasses insensitively to the current leaking from the heater and also eliminates the disadvantages of the conventional structure, as illustrated in FIG. 9, that electric disconnections between the terminals P1 and P2 and the respective cells 2, 3, and 4 or cracks occur in the through holes SH. This results in improved production efficiency and decreased production costs of the gas sensor element.

In the preferred mode of the invention, the method further comprises the steps of firing the laminated body and them forming an insulating layer between a portion of a surface of the laminated body, after which the conductive member is formed on the insulating layer.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is an exploded perspective view which shows a gas sensor element according to the first embodiment of the invention;

FIG. 2(a) is a longitudinal sectional view which shows the gas sensor element as illustrated in FIG. 1;

FIG. 2(b) is a transverse sectional view taken along the line A-A in FIG. 2(a);

FIG. 3(a) is a longitudinal sectional view which shows a gas sensor element according to the second embodiment of the invention;

FIG. 3(b) is a transverse sectional view taken along the line A-A in FIG. 3(a);

FIG. 4(a) is a perspective view which shows the gas sensor element as illustrated in FIG. 1;

FIG. 4(b) is a perspective view which shows a modification of the gas sensor element of FIG. 1;

FIG. 5 is a longitudinal sectional view which shows a gas sensor element according to the third embodiment of the invention;

FIG. 6 is an exploded perspective view which shows the gas sensor element of FIG. 5;

FIG. 7(a) is a perspective view which shows the gas sensor element as illustrated in FIG. 5;

FIG. 7(b) is a perspective view which shows a modification of the gas sensor element as illustrated in FIG. 7(a);

FIG. 8(a) is a longitudinal sectional view which shows a conventional gas sensor element;

FIG. 8(b) is a transverse sectional view taken along the line A-A in FIG. 8(a); and

FIG. 9 is an exploded perspective view which shows the gas sensor element as illustrated in FIGS. 8(a) and 8(b).

### DESCRIPTION OF THE PREFERRED EMBODIMENTS

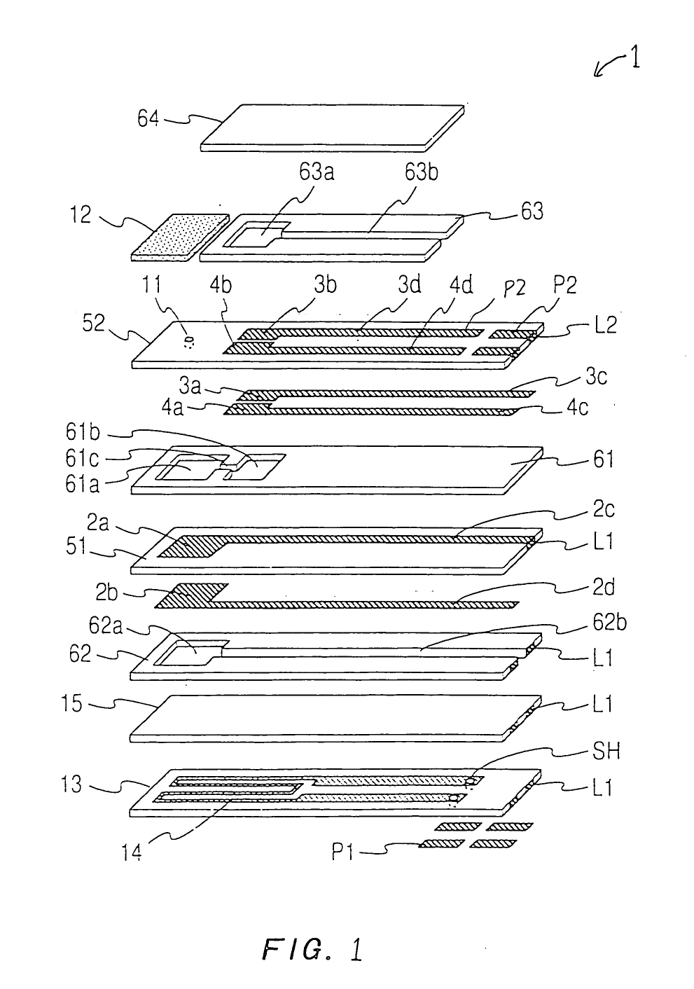

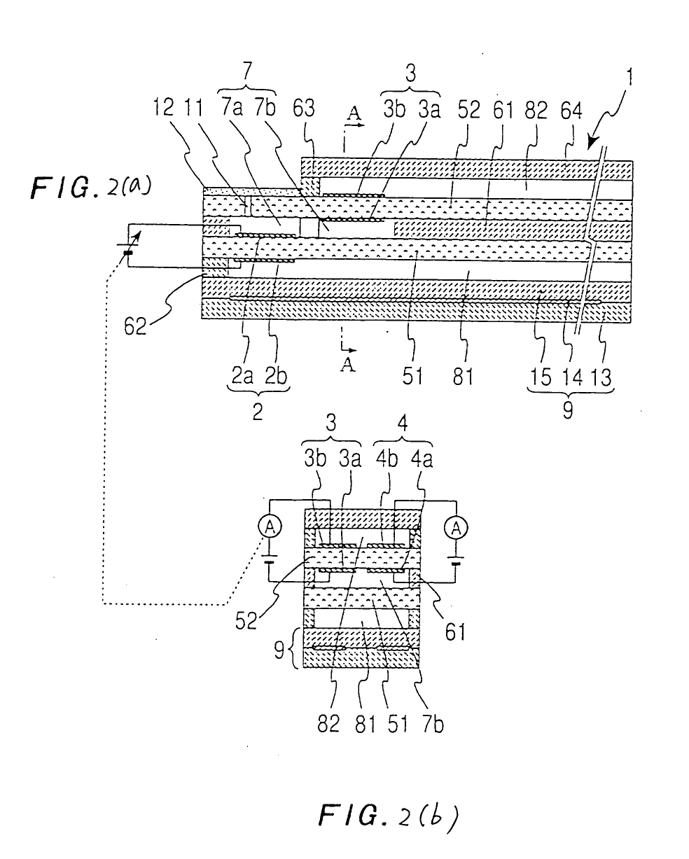

Referring to the drawings, wherein like reference numbers refer to like parts in several views, particularly to FIGS. 1, 2(a), and 2(b), there is shown a gas sensor element 1 according to the first embodiment of the invention which may be used to measure the concentration of a preselected component of exhaust emissions of an automotive engine such as nitrogen oxides (NOx) for use in engine burning control and/or catalytic systems. In practice, the gas sensor element 1 is disposed within a hollow cylindrical casing and covered at a head portion thereof with a protective cover assembly. The gas sensor element 1 is so mounted in a wall of an exhaust pipe of the engine so as to expose the head portion to the exhaust emissions of the engine and also expose a base portion thereof to the air used as a reference gas.

The gas sensor element 1 consists essentially of oxygen ion-conductive solid electrolyte layers 51 and 52, spacers 61, 62, 63, and 64, and a heater 9. The solid electrolyte layer 51 forms an oxygen pump cell 2. The solid electrolyte layer 52 forms an oxygen monitor cell 3 and a sensor cell 4. The spacer 61 defines an inner cavity 7. The spacers 62, 63, and 64 form reference gas chambers 81 and 82. As clearly shown in FIG. 2(a), on the heater 9, the spacer 62, the solid electrolyte layer 51, the spacer 61, the solid electrolyte layer 52, and the spacers 63 and 64 are laminated in this order.

The inner cavity 7 servers as a gas chamber into which gasses to be measured (will also be referred to as measurement gasses below) are introduced from outside the gas sensor element 1. The inner cavity 7 is, as clearly shown in FIG. 1, defined by openings 61a and 61b formed in the spacer 61 interposed between the solid electrolyte layers 51 and 52. The openings 61a and 61b communicate with each other through an orifice 61c. The orifice 61c separates the inner cavity 7 into a first measurement gas chamber 7a close to a head of the gas sensor element 1 and a second measurement gas chamber 7b close to a base portion of the gas sensor element 1.

The first measurement gas chamber 71 communicates with a measurement gas atmosphere (e.g., the inside of the exhaust pipe of the engine) through a pinhole 11 passing through a head portion of the solid electrolyte layer 52. The pinhole 11 works as a diffusion resistance and has a size selected to provide a desired diffusion rate to the measurement gasses introduced into the first and second measurement gas chambers 7a and 7b.

The solid electrolyte layer 52 has affixed thereto a porous protective layer 12 made of porous alumina which covers the pinhole 11 and is exposed to the measurement gas atmosphere. The solid electrolyte layer 52 serves to avoid clogging of the pinhole 11 and poisoning of electrodes, as will be described later, exposed to the inner cavity 7.

The spacer 62 has formed therein, as shown in FIG. 1, an opening 62a which defines the reference gas chamber 81 between the solid electrolyte layers 51 and 52. The spacer 63 has formed therein an opening 63a which defines the reference gas chamber 82 above the solid electrolyte layer 52. The holes 62a and 63a both communicate with the atmosphere through air paths 62b and 63b which are formed in the spacers 62 and 63 and extend in a lengthwise direction of the gas sensor element 1. The air is introduced into the reference gas chambers 81 and 82 through the air paths 62b and 63b, respectively.

The spacers 61, 62, 63, and 64 defining the inner cavity 7 and the reference gas chambers 81 and 82 are made of an insulating material such as alumina. The solid electrolyte layers 51 and 52 forming the oxygen pump cell 2, the oxygen monitor cell 3, and the sensor cell 4 are made of an oxygen ion-conductive solid electrolyte such as zirconia or ceria.

The oxygen pump cell 2 is, as clearly shown in FIGS. 2(a) and 2(b), made up of the solid electrolyte layer 51 and electrodes 2a and 2b which are affixed to surfaces of the solid electrolyte layer 51 and opposed to each other. The oxygen pump cell 2 works to dissociate or ionize oxygen molecules (O₂) contained in the reference gas (i.e. the air) existing inside the reference gas chamber 81 and pump them into the first measurement gas chamber 7a or to dissociate or ionize and pump oxygen molecules (O₂) existing within the first measurement gas chamber 7a into the reference gas chamber 81, thereby adjusting the concentration of oxygen within the inner cavity 7 to a desired value. The electrode 2a is disposed on the upper surface of the solid electrolyte layer 51 and exposed to the first measurement gas chamber 7a located upstream of the second measurement gas chamber 7b. The electrode 2b is disposed on the lower surface of the solid electrolyte layer 51 and exposed to the reference gas chamber 81.

The sensor cell 4 is, as clearly shown in FIG. 2(b), made up of the solid electrolyte layer 52 and electrodes 4a and 4b which are affixed to surfaces of the solid electrolyte layer 52 and opposed to each other. The sensor cell 4 works to measure the concentration of a selected component of the measurement gasses, i.e., NOx. The electrode 4a is disposed on the lower surface of the solid electrolyte layer 52 and exposed to the second measurement gas chamber 7b located downstream of the first measurement gas chamber 7a. The electrode 4b is disposed on the upper surface of the solid electrolyte layer 52 and exposed to the reference gas chamber 82.

The oxygen monitor cell 3 is made up of the solid electrolyte layer 52 and electrodes 3a and 3b which are affixed to the surfaces of the solid electrolyte layer 52 and opposed to each other. The oxygen monitor cell 3 works to measure or monitor the concentration of oxygen within the inner cavity 7 in the same manner as that in the oxygen pump cell 2. The electrode 3a is disposed on the lower surface of the solid electrolyte layer 52 and exposed to the second measurement gas chamber 7b. The electrode 3b is disposed on the upper surface of the solid electrolyte layer 52 and exposed to the reference gas chamber 82. It is advisable that the electrodes 3a and 3b of the oxygen monitor cell 3 and the electrodes 4a and 4b of the sensor cell 4 be located at the same position in a direction of a flow of the measurement gasses because the concentrations of oxygen in the vicinity of the electrodes 3a and 4b within the second measurement gas chamber 7b are adjusted to substantially the same value.

The electrodes 2a and 3a of the oxygen pump cell 2 and the oxygen monitor cell 3 are preferably made of material which is lower in ability to decompose NOx, that is, inactive with respect to NOx contained in the measurement gasses. For instance, they are each made of a porous cermet electrode containing Pt and Au as metallic main components thereof. It is advisable that a metal component of the porous cermet electrodes contain 1% to 10% by weight of Au. The porous cermet electrode may be formed by making paste containing metal alloy powder and ceramics such as zirconia or alumina and baking it.

The electrode 4a of the sensor cell 4 is preferably made of material which is higher in ability to decompose NOx, that is, highly active to NOx contained in the measurement gasses. For instance, a porous cermet electrode which contains main components of Pt and Rh may be used. It is advisable that a metal component of the cermet electrode contain 1% to 50% by weight of Rh. The electrodes 2b, 3b, and 4b of the oxygen pump cell 2, the oxygen monitor cell 3, and the sensor cell 4 are preferably made of a Pt-cermet electrodes.

The electrodes 2a and 2b of the oxygen pump cell 2, the electrodes 3a and 3b of the oxygen monitor cell 3, and the electrodes 4a and 4b of the sensor cell 4, as clearly shown in FIG. 1, have leads 2c, 2d, 3c, 3d, 4c, and 4d for picking up electric signals therefrom. It is advisable that insulating layers (not shown) made of, for example, alumina be formed on areas of the opposed major surfaces of the solid electrolyte layers 51 and 52 other than areas on which the electrodes 2a, 2b, 3a, 3b, 4a, and 4b are formed, especially between the leads 2c, 2d, 3c, 3d, 4c, and 4d and the surfaces of the solid electrolyte layers 51 and 52.

The heater 9 is made of a lamination of a heater sheet 13 and an insulating layer 15 made of alumina. The heater sheet 13 is made of an insulating material such as alumina and has patterned thereon a heater electrode 14 which is supplied with electric power to heat the cells 2, 3, and 4 up to a given activatable temperature. The heater electrode 14 may be implemented by a cermet electrode made of Pt and ceramic such as alumina.

The heater electrode 14 is connected electrically to terminals P1 (also called pad electrodes) through holes SH formed on the heater sheet 13. The terminals P1 are affixed to the bottom surface of the heater 9.

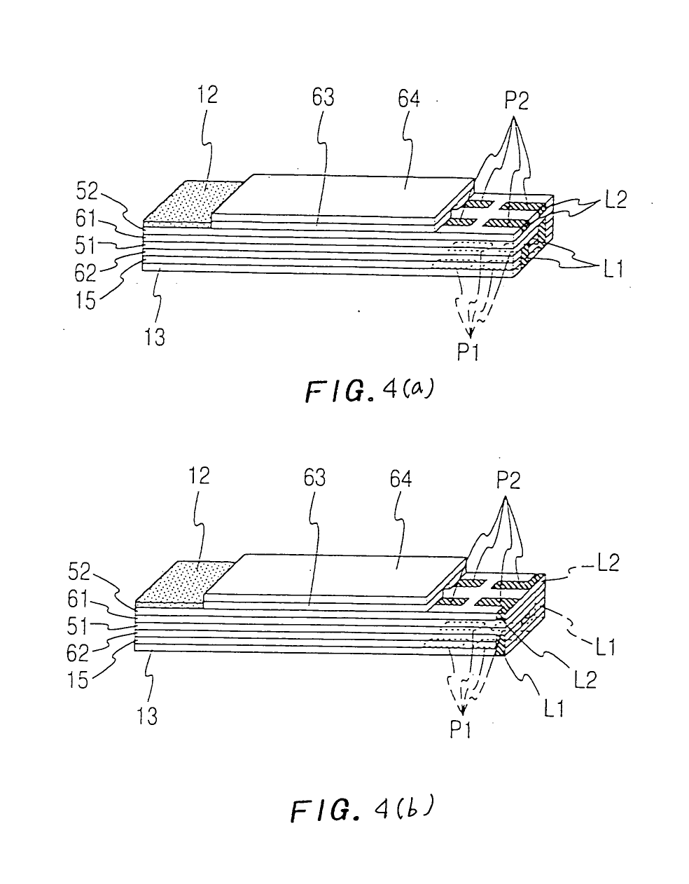

The electrodes 2a and 2b of the oxygen pump cell 2, are, as shown in FIGS. 1 and 4(a), connected to the terminals P1 through the lead 2c and 2d and conductive lines L1 formed on end surfaces of the solid electrolyte layer 51, the spacer 62, the alumina layer 15, and the heater sheet 13. The electrodes 3a and 3b of the oxygen monitor cell 3 are connected to two of four terminals P2 through the leads 3c and 3d and conductive lines L2 formed on an end surface of the solid electrolyte layer 52. Similarly, the electrodes 4a and 4b of the sensor cell 4 are connected to the other two terminals P2 through the leads 4c and 4d. The terminals P2 are formed on the upper surface of the solid electrolyte layer 52 and exposed outside the sensor element 1 without being covered with the spacers 63 and 64.

The terminals P1 and P2 are connected electrically to an external control circuit (not shown) through leads brazed or joined thereto using crimping terminals for transmission of signals between the cells 2, 3, and 4 and the heater 9 and the external control circuit. It is advisable that an insulating film made of alumina be formed between the terminals P1 and P2 and the surface of the sensor element 1.

The sensor element 1 may be manufactured in the following steps.

First, unbaked zirconia sheets for use in making the solid electrolyte layers 51 and 52 and unbaked alumina sheets for use in making the spacers 61, 62, 63, and 64, the heater sheet 13, and the alumina layer 15 are prepared. The sheets may be made by using a doctor blade or by extrusion molding.

Next, on given areas of the sheets for the solid electrolyte layers 51 and 51 and the heater sheet 13, the electrodes 2a, 2b, 3a, 3b, 4a, and 4b, the heater electrode 14, the leads 2c, 2d, 3c, 3d, 4c, and 4d, and the terminals P1 and P2 are formed by means of, for example, screen printing.

Subsequently, the sheets are laminated in the order, as illustrated in FIG. 1, and baked to make a solid lamination. Afterwards, a conductive paste whose main component is Pt is applied to an end surface of the solid lamination to form the conductive lines L1 and L2 which establish, as described above, electric connections of the electrodes 2a, 2b, 3a, 3b, 4a, and 4b of the cells 2, 3, and 4 to the terminals P1 and P2. Such formation minimizes the possibility of electric disconnections or physical cracks which may arise in a case where the electrodes 2a to 4b are connected to the terminals P1 and P2 through holes instead of the conductive lines L1 and L2. The conductive line L1 and L2 are formed on the end surface where the temperature will be the lowest within the sensor element 1, thereby providing the advantage that it is possible to increase the insulation resistance among the cells 2, 3, and 4. The increasing of the insulation resistance may be achieved by forming an alumina insulating film between the conductive lines L1 and L2 and the end surface of the sensor element 1.

The location of the conductive lines L1 and L2 is not limited to the end surface of the sensor element, as illustrated in FIG. 4(a). For instance the conductive lines L1 and L2 may be, as shown in FIG. 4(b), formed on a side surface (a right side surface, as viewed in the drawing), of the base portion of the sensor element 1 after the lamination is baked.

In operation, the measurement gasses, e.g., exhaust gasses of an automotive engine containing O₂, NOx, H₂O, etc. are admitted into the first measurement gas chamber 7a of the inner cavity 7 through the porous protective layer 12 and the pinhole 11. The amount of the exhaust gasses entering the inner cavity 7 per unit time depends upon the diffusion resistances of the porous protective layer 12 and the pinhole 11. The exhaust gasses pass through the orifice 16c and reach the second measurement gas chamber 7b.

Application of voltage across the electrodes 2a and 2b of the oxygen pump cell 2 so that a positive potential may be developed at the electrode 2b exposed to the reference gas chamber 81 will cause oxygen molecules within the first measurement gas chamber 7a to be reduced or ionized on the electrode 2a which are, in turn, pumped or transferred to the electrode 2b. Conversely, application of voltage across the electrodes 2a and 2b of the oxygen pump cell 2 so that a positive potential may be developed at the electrode 2a exposed to the reference gas chamber 81 will cause oxygen molecules within the exhaust pipe of the engine to be reduced or ionized on the electrode 2b and pumped or transferred to the electrode 2a. With such oxygen pumping, the concentration of oxygen molecules within the inner cavity 7 is controlled by changing the degree and orientation of the voltage applied across the electrodes 2a and 2b of the oxygen pump cell 2.

Application of voltage (e.g., 0.40V) across the electrodes 3a and 3b of the oxygen monitor cell 3 so that a positive potential may be developed at the electrode 3b exposed to the reference gas chamber 82 will cause oxygen molecules within the second measurement gas chamber 7b to be ionized on the electrode 3a and pumped or transferred to the electrode 3b. The electrode 3a is, as described above, a Pt-Au cermet electrode inactive with NOx that is a target gas component to be measured, therefore, an oxygen ion current flows between the electrodes 3a and 3b as a function of the amount of O₂ passing through the porous protective layer 12, the pinhole 11, the first measurement gas chamber 7a and entering the second measurement gas chamber 7b regardless of the amount of NOx. The concentration of oxygen molecules within the second measurement gas chamber 7b is, thus, kept constant by measuring the current flowing between the electrodes 3a and 3b and controlling the voltage applied to the electrodes 2a and 2b of the oxygen pump cell 2 so as to keep the current at a constant value (e.g., 0.2 μA).

Application of a given voltage (e.g., 0.40V) across the electrodes 4a and 4b of the sensor cell 4 so that a positive potential may be developed at the electrode 4b exposed to the reference gas chamber 82 will cause oxygen molecules and NOx molecules within the second measurement gas chamber 7b of the inner cavity 7 to be ionized on the electrode 4a, so that oxygen ions are pumped or transferred to the electrode 4b because the electrode 4a is, as described above, implemented by the Pt—Rh cermet electrode which is active with NOx. The oxygen pump cell 2 is, as described above, so controlled that the current flowing between the electrodes 3a and 3b of the oxygen monitor cell 3 may be kept at a constant level (e.g., 0.2 μA), so that the current flowing between the electrodes 4a and 4b of the sensor cell 4 is kept at a constant level (e.g., 0.2 μA) in the absence of NOx within the exhaust gasses. In the presence of NOx in the exhaust gasses, the current produced by the sensor cell 4 increases as a function of the concentration of NOx within the second measurement gas chamber 7b. Specifically, the concentration of NOx contained in the exhaust gasses is determined using an output of the sensor cell 4.

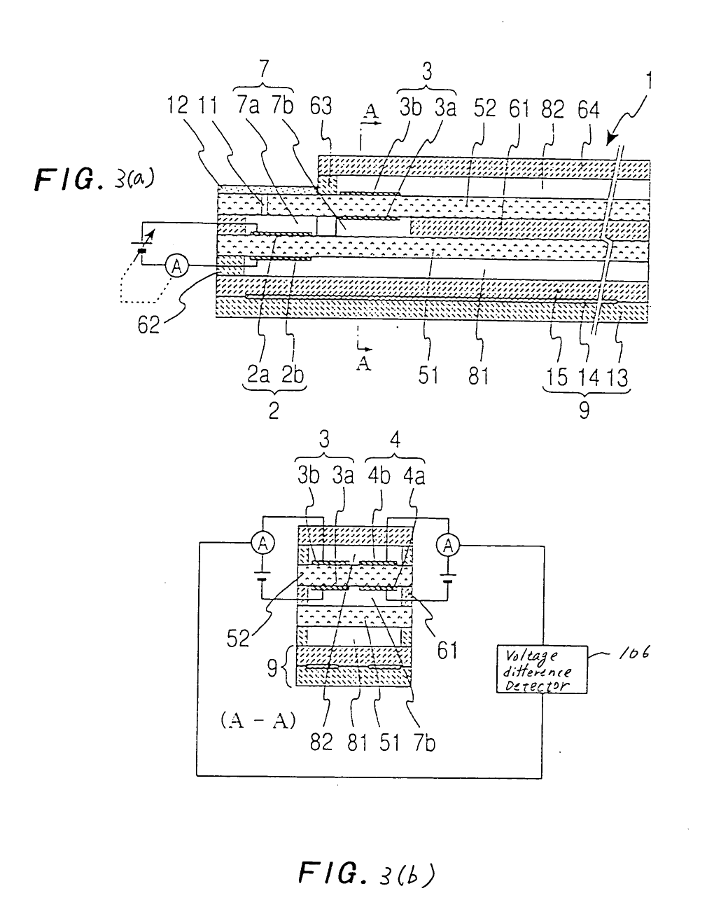

FIGS. 3(a) and 3(b) show the gas sensor element 1 according to the second embodiment of the invention which is different from the first embodiment in that the voltage which is determined using an applied voltage-to-resultant current map so that the oxygen pump cell 2 may produce a limiting current as a function of the concentration of oxygen within the first measurement gas chamber 7a is applied to the oxygen pump cell 2 to kept the concentration of oxygen at a given lower level within the first measurement gas chamber 7a. The physical structure of the gas sensor element 1 is identical, and explanation thereof in detail will be omitted here.

The above manner to control the concentration of oxygen within the inner cavity 7, however, has the drawback in that the concentration of oxygen within the second measurement gas chamber 7b tends to vary as compared with the control in the first embodiment using the output of the oxygen monitor cell 3. Therefore, use of the current flowing between the electrodes 4a and 4b of the sensor cell 4 as it is will result in decreased accuracy of determining the concentration of NOx. In order to avoid this problem, a current difference measuring circuit 106, as shown in FIG. 3(b), is used to measure a difference in current flowing between the electrodes 3a and 3b of the oxygen monitor cell 3 and between the electrodes 4a and 4b of the sensor cell 4 to determine the concentration of NOx, thereby resulting in increased NOx measurement accuracy independent of a change in concentration of oxygen within the second measurement gas chamber 7b.

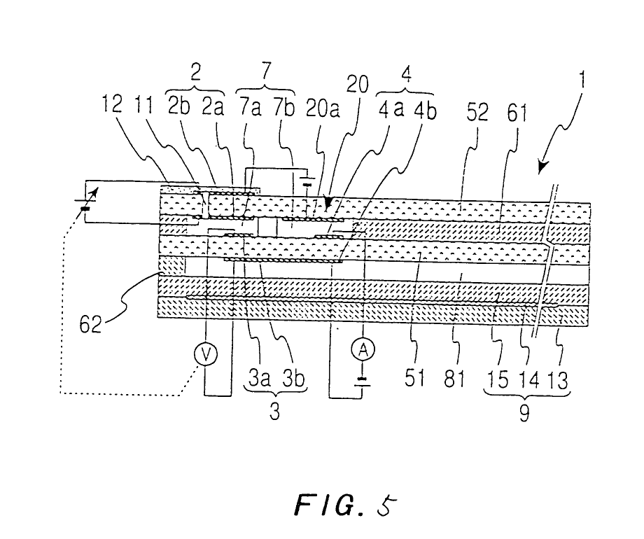

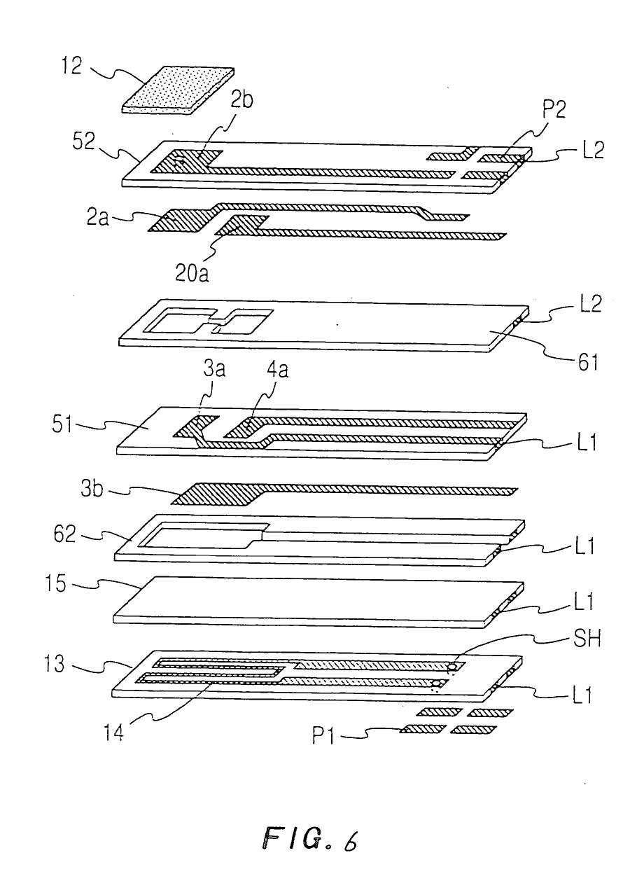

In the above embodiments, the determination of concentration of oxygen within the second measurement gas chamber 7b is achieved using the current flowing through the oxygen monitor cell 3, but however, it may alternatively be made using an electromotive force developed in the oxygen monitor cell 3. This will be described below as the third embodiment with reference to FIGS. 5 and 6 which is different from the first embodiment in locations of the oxygen monitor cell 3 and the sensor cell 4, use of an additional oxygen pump cell 20, and the absence of the reference gas chamber 82.

The oxygen pump cell 2 is made up of the solid electrolyte layer 52 and the electrodes 2a and 2b affixed to the upper and lower surfaces of the solid electrolyte layer 52. The electrode 2a is exposed to the first measurement gas chamber 7a. The electrode 2b is exposed to the exhaust gasses. The oxygen monitor cell 3 is made up of the solid electrolyte layer 51 and the electrodes 3a and 3b. The electrode 3a is exposed to the first measurement gas chamber 7a. The electrode 3b is exposed to the reference gas chamber 81. The sensor cell 4 is made up of the solid electrolyte layer 51 and the electrodes 4a and 4b. The electrode 4a is exposed to the second measurement gas chamber 7b. The electrode 4b is affixed to the lower surface of the solid electrolyte layer 51 and shared with the electrode 3b of the oxygen monitor cell 3.

The second oxygen pump cell 20 is made up of a portion of the solid electrolyte layer 52 and an electrode 20a and the electrode 2b. The electrode 20a is affixed to the lower surface of the solid electrolyte layer 52 and exposed to the second measurement gas chamber 7b. The electrode 2b is shared with the oxygen pump cell 2. The second oxygen pump cell 20 works to pump oxygen molecules flowing into the second measurement gas chamber 7b without pumped by the oxygen pump cell 2 outside the gas sensor element 1.

The sensor element 1 of this embodiment is manufactured in a manner similar to the first embodiment.

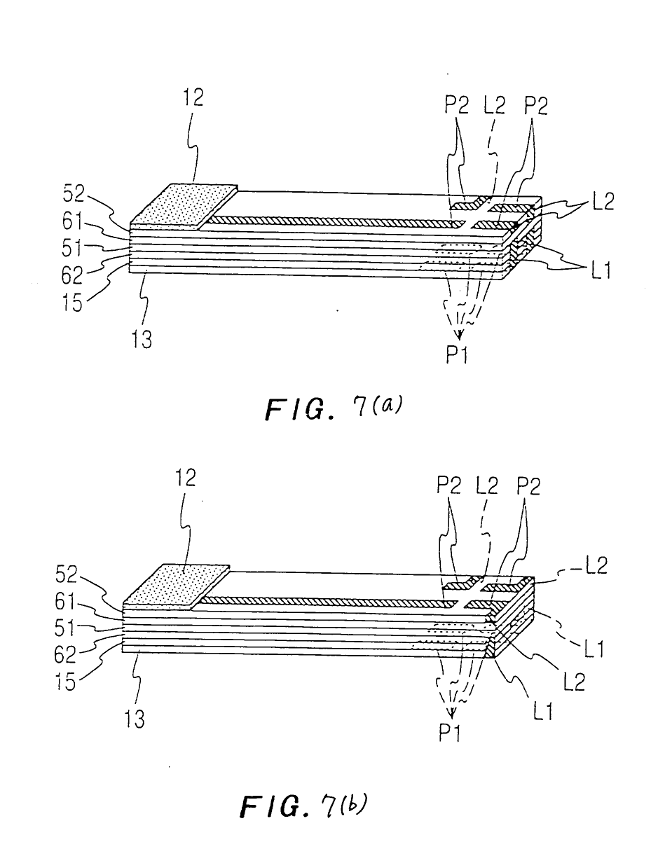

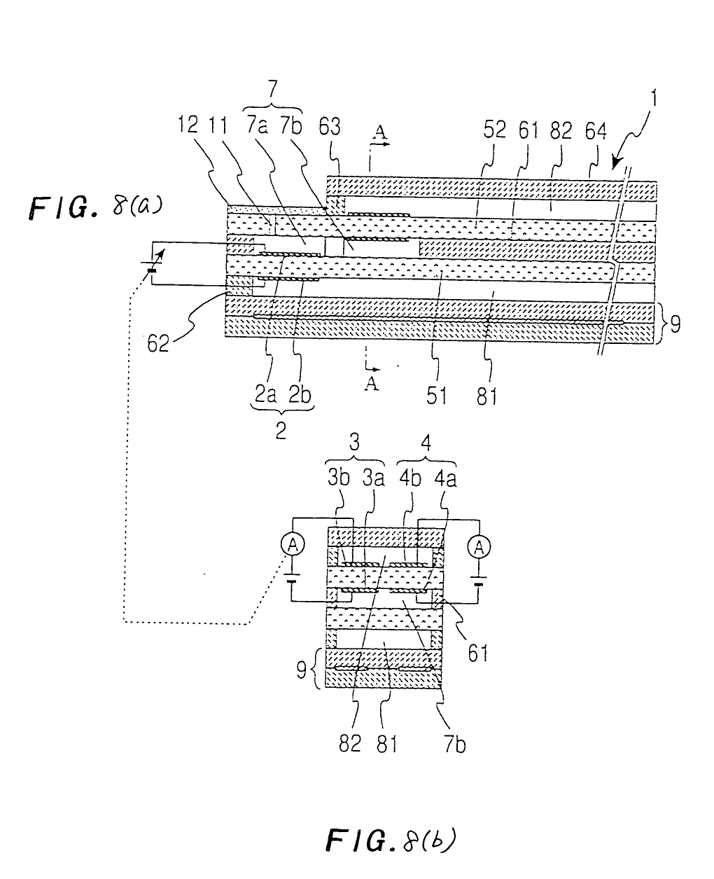

Specifically, unbaked sheets for use in making the cells 2, 3, 4, and 20, the spacers 61 and 62, the alumina layer 15, and the heater sheet 13 are prepared and laminated in the order, as illustrated in FIG. 4. The lamination is baked. Finally, a conductive paste is applied to an end surface and a side surface of the baked or solid lamination to form the conductive lines L1 and L2. The conductive lines L2 establish, as can be seen from FIGS. 6 and 7(a), electric connections of the electrode 2a of the oxygen pump cell 2, the electrode 20a of the second oxygen pump cell 20, and the electrode 4a of the sensor cell 4 to the terminals P2. The conductive lines L1 establish electric connections of the electrode 3a of the oxygen monitor cell 3 and the electrode 4b of the sensor cell 4 shared as the electrode 3b with the oxygen monitor cell 3 to the terminals P1. The formation of the conductive lines L1 and L2 on the end and side surfaces of the lamination minimizes the possibility of electric disconnections or physical cracks which may arise in a case where the electrodes are connected to the terminals P1 and P2 through holes instead of the conductive lines L1 and L2. The conductive line L1 and L2 are formed on the surfaces of the lamination where the temperature will be the lowest within the sensor element 1, thereby providing the advantage that the insulation resistance among the cells 2, 3, 4, and 20 is permitted to be increased. It is advisable for increasing the insulation resistance that an alumina insulating film be formed between the conductive lines L1 and L2 and the surfaces of the sensor element 1 after the lamination of baked.

The conductive lines L1 and L2 may alternatively, as shown in FIG. 7(b), formed only right side portions, as viewed in the drawing, of side surfaces of the sensor element 1.

The operation of the sensor element 1 of this embodiment will be described below with reference to FIG. 5.

The electrode 3a of the oxygen monitor cell 3 is exposed to the first measurement gas chamber 7a. The electrode 3b of the oxygen monitor cell 3 is exposed to the reference gas chamber 81 into which the air is admitted. Between the electrodes 3a and 3b, an electromotive force arises from a difference in concentration of oxygen between the first measurement gas chamber 7a and the reference gas chamber 81 according to the Nernst equation. Usually, the concentration of oxygen within the reference gas chamber 81 is constant, so that the electromotive force is developed between the electrodes 3a and 3b as a function of the concentration of oxygen within the first measurement gas chamber 7a. The concentration of oxygen within the gasses flowing into the second measurement gas chamber 7b can, therefore, be kept constant by controlling the voltage applied across the electrodes 2a and 2b of the oxygen pump cell 2 so as to keep the electromotive force appearing between the electrodes 3a and 3b at a constant level. The second oxygen pump cell 20, as described above, works to pump oxygen molecules flowing into the second measurement gas chamber 7b without discharged by the oxygen pump cell 2 outside the gas sensor element 1, thereby causing the concentration of oxygen within the second measurement gas chamber 7b to be almost zero (0), which ensures high accuracy of determining the concentration of NOx through the sensor cell 4.

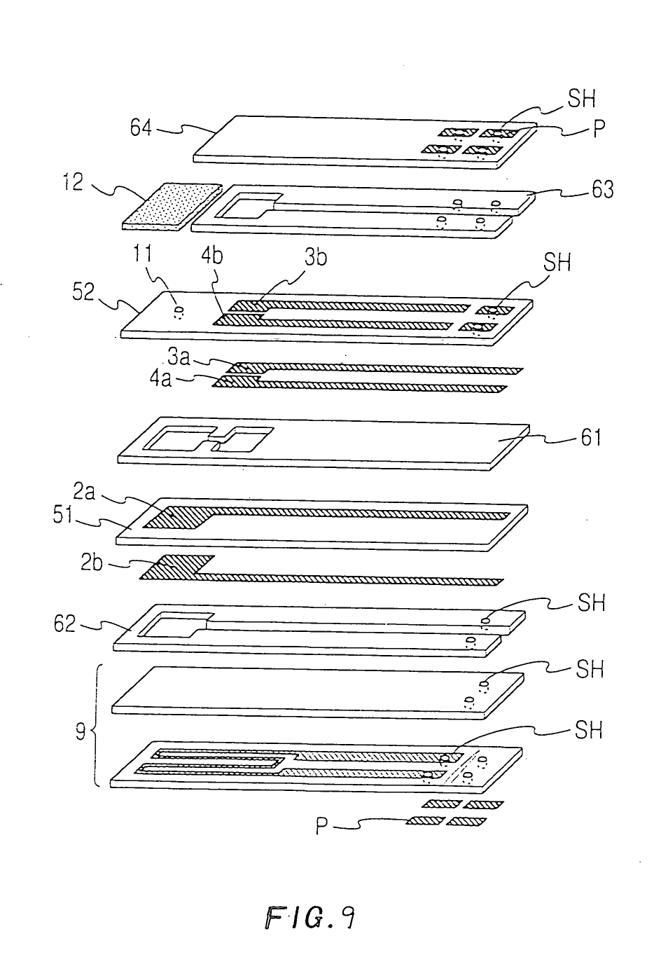

As described above, in each of the first and second embodiments, the cell 2, 3, and 4 are electrically joined to the terminals P1 and P2 through the conductive lines L1 and L2 formed on selected portions of the outer surface of the sensor element member without use of the through hole SH in the conventional structure, as illustrated in FIG. 9. This structure provides required insulation resistance between the heater 9 and the respective cells 2, 3, and 4 to ensure the accuracy of measuring the concentration of NOx insensitively to the current leaking from the heater 9. The structure also eliminates the disadvantages of the conventional structure that electric disconnections between the terminals P1 and P2 and the respective cells 2, 3, and 4 or cracks occur in the through holes SH. This results in improved production efficiency and decreased production costs of the gas sensor element 1.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor element comprising:
a laminated body having formed therein an inner chamber into which measurement gasses are admitted under a given diffusion resistance;
an oxygen pump cell formed in said laminated body, including an oxygen ion-conducting solid electrolyte body and first and second pump cell electrodes affixed to surfaces of the solid electrolyte body, the first pump cell electrode being exposed to said inner chamber, said oxygen pump cell being responsive to application of a voltage across the first and second pump cell electrodes to selectively pump oxygen molecules into and out of said inner chamber for adjusting a concentration of oxygen within said inner chamber to a desired value;
a sensor cell formed in said laminated body, including an oxygen ion-conducting solid electrolyte body and first and second sensor cell electrodes, the first sensor cell electrode being exposed to said inner chamber, said sensor cell working to produce a signal as a function of a concentration of a predetermined component of the measurement gasses;
a heater disposed in said laminated body, working to heat said oxygen pump cell and said sensor cell up to a desired activatable temperature;
terminals affixed to a surface of said laminated body for establishing transmission of electric signals between the gas sensor element and an external device; and
a conductive member formed on an outer surface of said laminated body which establishes an electric connection between one of said terminals and a lead of at least one of said oxygen pump cell and said sensor cell.

2. A gas sensor element as set forth in claim 1, further comprising a monitor cell and a second conductive member, said monitor cell being formed in said laminated body, including an oxygen ion-conducting solid electrolyte body and first and second monitor cell electrodes, the first monitor cell electrode being exposed to said inner chamber, said monitor cell working to produce a signal indicative of a concentration of oxygen within said inner chamber, said second conductive member establishing an electric connection between a lead of said monitor cell and a terminal formed on the surface of said laminated body for establishing transmission of a signal between the lead of said monitor cell and the external device.

3. A gas sensor element as set forth in claim 2, wherein the voltage applied to said oxygen pump cell is controlled as a function of the signal produced by said monitor cell.

4. A gas sensor element as set forth in claim 1, wherein the signal produced by said sensor cell indicating the concentration of the predetermined component of the measurement gasses is provided by a current flowing through said sensor cell.

5. A gas sensor element as set forth in claim 2, wherein the signal produced by said monitor cell indicating the concentration of oxygen within said inner chamber is provided by a current flowing through said monitor cell.

6. A gas sensor element as set forth in claim 2, wherein the signal produced by said monitor cell indicating the concentration of oxygen within said inner chamber is provided by an electromotive force developed in said monitor cell.

7. A gas sensor element as set forth in claim 5, wherein the concentration of the predetermined component of the measurement gasses is determined as a function of a difference between values of the currents flowing through said sensor cell and said monitor cell.

8. A gas sensor element as set forth in claim 1, further comprising an insulating layer interposed between said conductive member and the surface of said laminated body.

9. A method of producing a gas sensor element comprising the steps of:
preparing a laminated body having formed therein an inner chamber into which measurement gasses are admitted under a given diffusion resistance, said laminated body including an oxygen pump cell, a sensor cell, a monitor cell, and a heater, the oxygen pump cell including an oxygen ion-conducting solid electrolyte body and first and second pump cell electrodes affixed to surfaces of the solid electrolyte body one of which is exposed to said inner chamber, said oxygen pump cell being responsive to application of a voltage across the first and second pump cell electrodes to selectively pump oxygen molecules into and out of said inner chamber for adjusting a concentration of oxygen within said inner chamber to a desired value, the sensor cell including an oxygen ion-conducting solid electrolyte body and first and second sensor cell electrodes one of which is exposed to said inner chamber, said sensor cell working to produce a signal as a function of a concentration of a predetermined component of the measurement gasses, the monitor cell including an oxygen ion-conducting solid electrolyte body and first and second monitor cell electrodes one of which is exposed to said inner chamber, said monitor cell working to produce a signal indicative of a concentration of oxygen within said inner chamber, the heater working to heat said oxygen pump cell, said sensor cell, and said monitor cell up to a desired activatable temperature;
affixing terminals to a surface of said laminated body for establishing transmission of electric signals between the gas sensor element and an external device; and
forming a conductive member on a surface of said laminated body which establishes an electric connection between one of said terminals and a lead of at least one of said oxygen pump cell and said sensor cell.

10. A method as set forth in claim 9, further comprising the steps of firing the laminated body and them forming an insulating layer between a portion of a surface of the laminated body, after which the conductive member is formed on the insulating layer.
